(19) United States
(12) Patent Application Publication
(10) Pub. No.: US 2022/0124614 A1
(43) Pub. Date: Apr. 21, 2022

(54) COMMUNICATIONS DEVICES, INFRASTRUCTURE EQUIPMENT AND METHODS

(71) Applicant: Sony Corporation, Tokyo (JP)

(72) Inventors: Shin Horng WONG, Basingstoke (GB); Martin Warwick BEALE, Basingstoke (GB)

(73) Assignee: Sony Group Corporation, Tokyo (JP)

(21) Appl. No.: 17/420,145

(22) PCT Filed: Jan. 10, 2020
(86) PCT No.: PCT/EP2020/050585

§ 371 Date: Jul. 1, 2021

(30) Foreign Application Priority Data
Jan. 11, 2019 (EP) 19151357.1

(51) Int. Cl. H04W 52/02; H04W 76/28

(52) U.S. Cl. CPC H04W 52/0216; H04W 76/28

(57) ABSTRACT

A communications device configured to transmit data to an infrastructure equipment of a wireless communications network is provided. The communications device is configured to periodically switch between an active operating mode and a reduced power operating mode in accordance with a discontinuous reception, DRX, operation. The communications device comprises transceiver circuitry configured to transmit signals and receive signals via a wireless access interface provided by the wireless communications network, and controller circuitry configured to control the transceiver circuitry to monitor for signals transmitted by the infrastructure equipment to the communications device, to receive, from the infrastructure equipment, a dynamic DRX indicator, DDI, the DDI indicating that the DRX operation should be updated by the communications device, and to update the DRX operation in accordance with the received DDI.

### BACKGROUND

### Field of Disclosure

The present disclosure relates generally to communications devices, infrastructure equipment and methods of operating communications devices and infrastructure equipment and specifically to communications devices configured operate in accordance with a discontinuous reception (DRX) operation.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to routinely and efficiently support communications with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a communications device configured to transmit data to an infrastructure equipment of a wireless communications network. The communications device is configured to periodically switch between an active operating mode and a reduced power operating mode in accordance with a discontinuous reception, DRX, operation. The communications device comprises transceiver circuitry configured to transmit signals and receive signals via a wireless access interface provided by the wireless communications network, and controller circuitry configured to control the transceiver circuitry to monitor for signals transmitted by the infrastructure equipment to the communications device , to receive, from the infrastructure equipment, a dynamic DRX indicator, DDI, the DDI indicating that the DRX operation should be updated by the communications device, and to update the DRX operation in accordance with the received DDI.

Embodiments of the present technique, which further relate to infrastructure equipment, methods of operating communications devices and infrastructure equipment, and circuitry for communications devices and infrastructure equipment, allow for the signalling and control of the ON duration of a communications device's DRX operation, thereby improving power saving at the communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 shows an example of a DRX cycle;

FIG. 4 shows a part schematic, part message flow diagram representation of a wireless communications network comprising a communications device and an infrastructure equipment in accordance with embodiments of the present technique;

FIG. 5 illustrates an example of how a default DRX ON period may be updated in accordance with embodiments of the present technique;

FIG. 6 illustrates an example of how an offset period may be configured resulting in a new active DRX period being outside of the default DRX ON period in accordance with embodiments of the present technique;

FIG. 7 shows an example of different UEs being configured with different offset period settings in accordance with embodiments of the present technique;

FIG. 8 shows an example of sub-DRX cycles in accordance with embodiments of the present technique;

FIG. 9 illustrates a first example of DDIs acting as keep alive signals within a DRX ON period in accordance with embodiments of the present technique;

FIG. 10 illustrates a second example of DDIs acting as keep alive signals indicating whether the current sub-DRX period is active or not in accordance with embodiments of the present technique;

FIG. 11 shows an example of two distinct active states within a DRX ON duration in accordance with embodiments of the present technique;

FIG. 12 shows an example of how a DDI may be carried by a compact DCI that is transmitted within the DRX ON duration in accordance with embodiments of the present technique;

FIG. 13 illustrates how a first active state may act as a DDI for a second active state in accordance with embodiments of the present technique; and

FIG. 14 is a flow diagram representation of a method of operating a communications device according to embodiments of the present technique.

### DETAILED DESCRIPTION OF THE EMBODIMENTS

Long Term Evolution Advanced Radio Access Technology (4G)

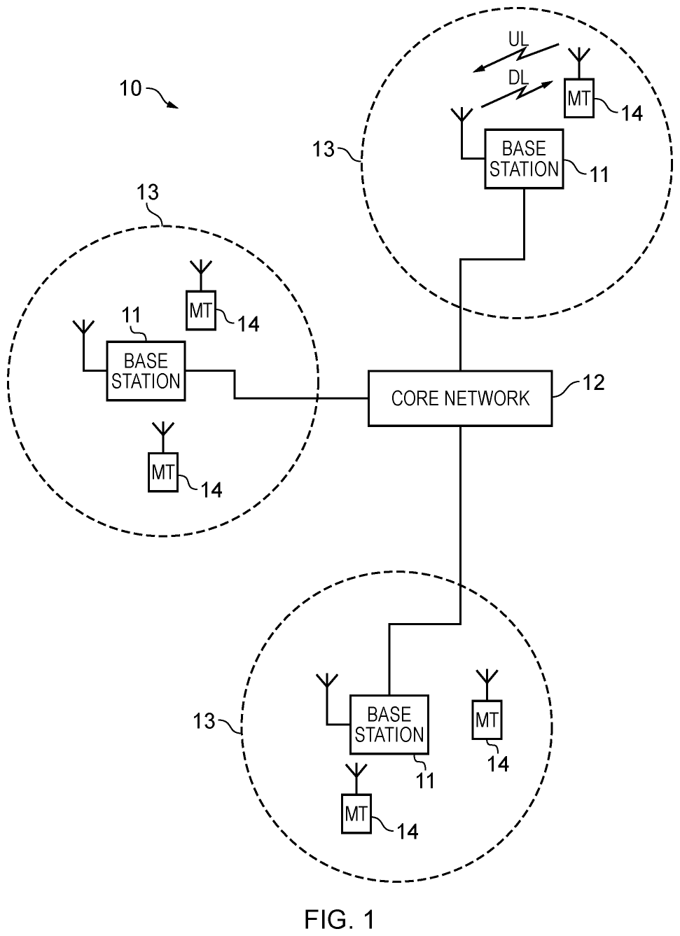

FIG. 1 provides a schematic diagram illustrating some basic functionality of a mobile telecommunications network/system 10 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 10 includes a plurality of base stations 11 connected to a core network 12. Each base station provides a coverage area 13 (i.e. a cell) within which data can be communicated to and from terminal devices 14. Data is transmitted from base stations 11 to terminal devices 14 within their respective coverage areas 13 via a radio downlink (DL). Data is transmitted from terminal devices 14 to the base stations 11 via a radio uplink (UL). The core network 12 routes data to and from the terminal devices 14 via the respective base stations 11 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

As mentioned above, the embodiments of the present disclosure can also find application with advanced wireless communications systems such as those referred to as 5G or New Radio (NR) Access Technology. The use cases that are considered for NR include:
Enhanced Mobile Broadband (eMBB)
Massive Machine Type Communications (mMTC)
Ultra Reliable & Low Latency Communications (URLLC) [2]
   eMBB services are characterised by high capacity with a requirement to support up to 20 Gb/s. The requirement for URLLC is a reliability of 1-10⁻⁵ (99.999%) for one transmission of a relatively short packet such as 32 bytes with a user plane latency of 1 ms.

The elements of the wireless access network shown in FIG. 1 may be equally applied to a 5G new RAT configuration, except that a change in terminology may be applied as mentioned above.

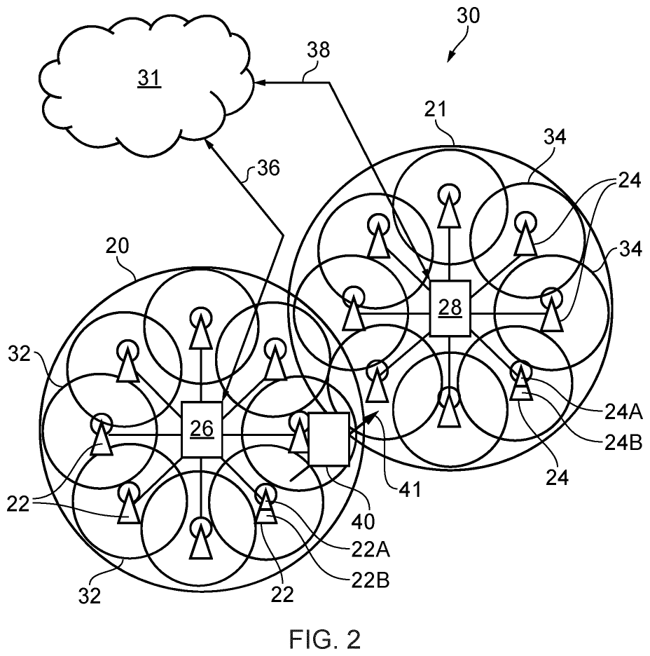

FIG. 2 is a schematic diagram illustrating a network architecture for a new RAT wireless mobile telecommunications network/system 30 based on previously proposed approaches which may also be adapted to provide functionality in accordance with embodiments of the disclosure described herein. The new RAT network 30 represented in FIG. 2 comprises a first communication cell 20 and a second communication cell 21. Each communication cell 20, 21, comprises a controlling node (centralised unit, CU) 26, 28 in communication with a core network component 31 over a respective wired or wireless link 36, 38. The respective controlling nodes 26, 28 are also each in communication with a plurality of distributed units (radio access nodes/remote transmission and reception points (TRPs)) 22, 24 in their respective cells. Again, these communications may be over respective wired or wireless links The distributed units (DUs) 22, 24 are responsible for providing the radio access interface for terminal devices connected to the network. Each distributed unit 22, 24 has a coverage area (radio access footprint) 32, 34 which together define the coverage of the respective communication cells 20, 21. Each distributed unit 22, 24 includes transceiver circuitry 22a, 24a for transmission and reception of wireless signals and processor circuitry 22b, 24b configured to control the respective distributed units 22, 24.

In terms of broad top-level functionality, the core network component 31 of the new RAT telecommunications system represented in FIG. 2 may be broadly considered to correspond with the core network 12 represented in FIG. 1, and the respective controlling nodes 26, 28 and their associated distributed units/TRPs 22, 24 may be broadly considered to provide functionality corresponding to base stations of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the terminal devices may lie with the controlling node/centralised unit and/or the distributed units/TRPs.

A terminal device 40 is represented in FIG. 2 within the coverage area of the first communication cell 20. This terminal device 40 may thus exchange signalling with the first controlling node 26 in the first communication cell via one of the distributed units 22 associated with the first communication cell 20. In some cases communications for a given terminal device are routed through only one of the distributed units, but it will be appreciated in some other implementations communications associated with a given terminal device may be routed through more than one distributed unit, for example in a soft handover scenario and other scenarios.

The particular distributed unit(s) through which a terminal device is currently connected through to the associated controlling node may be referred to as active distributed units for the terminal device. Thus the active subset of distributed units for a terminal device may comprise one or more than one distributed unit (DU/TRP). The controlling node 26 is responsible for determining which of the distributed units 22 spanning the first communication cell 20 is responsible for radio communications with the terminal device 40 at any given time (i.e. which of the distributed units are currently active distributed units for the terminal device). Typically this will be based on measurements of radio channel conditions between the terminal device 40 and respective ones of the distributed units 22. In this regard, it will be appreciated the subset of the distributed units in a cell which are currently active for a terminal device will depend, at least in part, on the location of the terminal device within the cell (since this contributes significantly to the radio channel conditions that exist between the terminal device and respective ones of the distributed units).

In at least some implementations the involvement of the distributed units in routing communications from the terminal device to a controlling node (controlling unit) is transparent to the terminal device 40. That is to say, in some cases the terminal device may not be aware of which distributed unit is responsible for routing communications between the terminal device 40 and the controlling node 26 of the communication cell 20 in which the terminal device is currently operating, or even if any distributed units 22 are connected to the controlling node 26 and involved in the routing of communications at all. In such cases, as far as the terminal device is concerned, it simply transmits uplink data to the controlling node 26 and receives downlink data from the controlling node 26 and the terminal device has no awareness of the involvement of the distributed units 22, though may be aware of radio configurations transmitted by distributed units 22. However, in other embodiments, a terminal device may be aware of which distributed unit(s) are involved in its communications. Switching and scheduling of the one or more distributed units may be done at the network controlling node based on measurements by the distributed units of the terminal device uplink signal or measurements taken by the terminal device and reported to the controlling node via one or more distributed units.

In the example of FIG. 2, two communication cells 20, 21 and one terminal device 40 are shown for simplicity, but it will of course be appreciated that in practice the system may comprise a larger number of communication cells (each supported by a respective controlling node and plurality of distributed units) serving a larger number of terminal devices.

It will further be appreciated that FIG. 2 represents merely one example of a proposed architecture for a new RAT telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2.

It will thus be appreciated the specific wireless telecommunications architecture in any given implementation is not of primary significance to the principles described herein. In this regard, certain embodiments of the disclosure may be described generally in the context of communications between network infrastructure equipment/access nodes and a terminal device, wherein the specific nature of the network infrastructure equipment/access node and the terminal device will depend on the network infrastructure for the implementation at hand. For example, in some scenarios the network infrastructure equipment/access node may comprise a base station, such as an LTE-type base station 11 as shown in FIG. 1 which is adapted to provide functionality in accordance with the principles described herein, and in other examples the network infrastructure equipment may comprise a control unit/controlling node 26, 28 and/or a TRP 22, 24 of the kind shown in FIG. 2 which is adapted to provide functionality in accordance with the principles described herein.

As is well understood, various wireless telecommunications networks, such as the LTE-based network represented in FIG. 1 and the NR-based network represented in FIG. 2, may support different Radio Resource Control (RRC) modes for terminal devices, typically including: (i) RRC idle mode (RRC_IDLE); and (ii) RRC connected mode (RRC_CONNECTED). When a terminal device transmits data, RRC connected mode is generally used. The RRC idle mode, on the other hand, is for terminal devices which are registered to the network (EMM-REGISTERED), but not currently in active communication (ECM-IDLE). Thus, generally speaking, in RRC connected mode a terminal device is connected to a radio network access node (e.g. an LTE base station) in the sense of being able to exchange user plane data with the radio network access node. Conversely, in RRC idle mode a terminal device is not connected to a radio network access node in the sense of not being able to communicate user plane data using the radio network access node. In idle mode the terminal device may still receive some communications from base stations, for example reference signalling for cell reselection purposes and other broadcast signalling. The RRC connection setup procedure of going from RRC idle mode to RRC connected mode may be referred to as connecting to a cell/base station.

For a terminal device in RRC idle mode the core network is aware that the terminal device is present within the network, but the radio access network (RAN) part (comprising radio network infrastructure equipment such as the base stations 11 of FIG. 1 and/or the combined TRPs/CUs of FIG. 2) is not. The core network is aware of the location of idle mode terminal devices at a paging tracking area level but not at the level of individual transceiver entities. The core network will generally assume a terminal device is located within the tracking area(s) associated with a transceiver entity most recently used for communicating with the terminal device, unless the terminal device has since provided a specific tracking area update (TAU) to the network. (As is conventional, idle mode terminal devices are typically required to send a TAU when they detect they have entered a different tracking area to allow the core network to keep track of their location.) Because the core network tracks terminal devices at a tracking area level, it is generally not possible for the network infrastructure to know which specific transceiver entities (radio network node) to use when seeking to initiate contact with a terminal device in idle mode. Consequently, and as is well known, when a core network is required to connect to an idle mode terminal device a paging procedure is used. In a typical currently deployed network, idle mode terminal devices are configured to monitor for paging messages periodically. For terminal devices (in connected and idle mode) operating in a discontinuous reception (DRX) mode this occurs when they wake up for their DRX wake time. Paging signals for a specific terminal device are transmitted in defined frames (Paging Frames)/sub-frames (Paging Occasions) which for a given terminal device may be derived from the International Mobile Subscriber Identifier (IMSI) of the terminal device, as well as paging related DRX parameters established in system information transmitted within the network.

Power saving is an important aspect of NR, and there are a number of different ways in which the battery life of a UE may be improved. One such way is by enabling DRX configuration to adapt to the UE's traffic, for example, the use of a Wake Up Signal (WUS) to indicate whether a UE should wake up during a DRX ON period. The WUS is a signal that is transmitted to a UE or a group of UEs prior to a DRX ON period or Paging Occasion to indicate whether the UE(s) needs to wake up during this ON period and monitor for possible traffic, e.g. monitor the PDCCH (Physical Downlink Control Channel). This recognises that not every DRX ON period contains traffic for the UE, and for such a case, the PDCCH monitoring consumes unnecessary power from the UE, which can be avoided with this WUS signal. Co-pending European patent applications filed with application numbers EP17169577.8 [3], EP17186065.3 [4], EP17186062.0 [5], and EP17201751.9 [6] address the use of WUS signals.

If the WUS is misdetected (i.e. a WUS is transmitted but the UE fails to detect it), then the UE would miss the corresponding paging message, and so the reliability of the paging is reduced. To avoid misdetection, another Power Saving Signal is proposed, where this signal is always transmitted prior to a paging occasion (PO) and would indicate to the UE whether it should Go To Sleep (i.e. there is no need for the UE to monitor for PDCCH and PDSCH (Physical Downlink Shared Channel)) or Wake Up (i.e.

monitor for PDCCH and PDSCH in the corresponding PO). This Go to sleep or wake Up Signal (GUS), which is known and proposed in [7], would therefore remove any misdetection since the UE would expect it to be there. The UE will miss a paging occasion if there is an incorrect detection at the UE; i.e. the UE mistakes a Wake Up for a Go To Sleep (GTS) indication. The drawback of using GUS is that it consumes a lot of resources, since it needs to be transmitted regardless of whether there is any potential paging message for the UE.

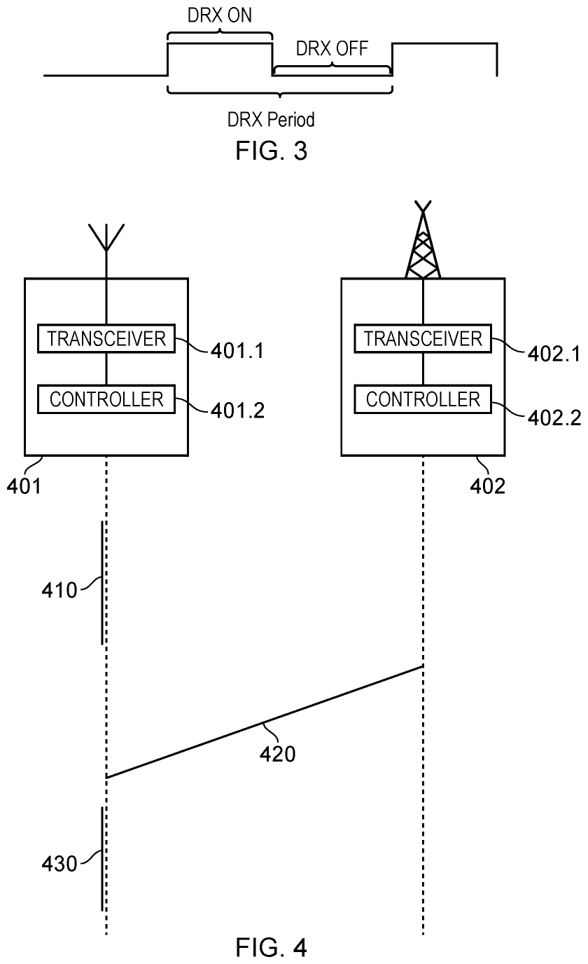

The basic DRX cycle is shown in FIG. 3, which consists of an ON period and an OFF period where the ON period occurs periodically at a fixed DRX period. It should be appreciated by those skilled in the art that such a basic operation may not always be efficient, particularly if a UE frequently does not receive any signals during the ON period (or active operating mode) of the DRX operation. Embodiments of the present disclosure introduce a mechanism to both provide information on, and to control and dynamically change the DRX ON duration and other characteristics of the DRX cycle, thus improving power saving capabilities.

Dynamic DRX On Duration

FIG. 4 shows a part schematic, part message flow diagram representation of a wireless communications network comprising a communications device 401 and an infrastructure equipment 402 in accordance with embodiments of the present technique. The communications device 401 and the infrastructure equipment 402 each comprise a transceiver (or transceiver circuitry) 401.1, 402.1, and a controller (or controller circuitry) 401.2, 402.2. The transceiver circuitry 401.1 and 402.2 comprises both transmitter and receiver elements. Each of the controllers 401.2, 402.2 may be, for example, a microprocessor, a CPU, or a dedicated chipset, etc. The communications device 401 is configured to periodically switch, in accordance with a discontinuous reception, DRX, operation, between an active operating mode in which the receiver of the communications device 401 is fully powered to monitor for received signals, and a reduced power operating mode in which the receiver of the communications device 401 is not provided with power to monitor for received signals.

The transceiver circuitry 401.1 and the controller circuitry 401.2 of the communications device 401 are configured in combination to monitor 410 for signals transmitted by the infrastructure equipment 402 to the communications device 401 to receive 420, from the infrastructure equipment 402, a dynamic DRX indicator, DDI, the DDI indicating that the DRX operation (i.e. at least the current or a next instance of the active operating mode—DRX ON—of the DRX operation) should be updated by the communications device 401, and to update 430 the DRX operation in accordance with the received DDI. The DDI may be received by the communications device from the infrastructure equipment while the communications device is in the active operating mode, though this is not always the case. It should be appreciated by those skilled in the art that, having transmitted the DDI to the communications device indicating that the DRX operation should be updated by the communications device, the infrastructure may then be configured to transmit signals to the communications device in accordance with the updated DRX operation indicated by the transmitted DDI. Of course, it is possible that the infrastructure equipment, having transmitted the DDI to the communications device indicating that it should update its DRX operation, actually may not then transmit any signals to the communications device.

Essentially, embodiments of the present technique introduce a Dynamic DRX Indicator (DDI) that signals updates to the ON duration of a DRX cycle. In an arrangement of embodiments of the present technique, the DDI consists of a time offset T_{OFFSET} and a new DRX duration T_{ON} as shown in FIG. 5. In other words, the DDI indicates that the communications device should change a length of time for which the communications device is in the active operating mode from a default active period to a new active period. The DDI indicates an offset period from a default time at which the communications device should switch into the active operating mode to a new time at which the communications device should switch into the active operating mode. In the example of FIG. 5, a DDI is transmitted prior to the DRX ON duration of interest, which changes the DRX ON duration to T_{ON} with a delayed start of T_{OFFSET}.

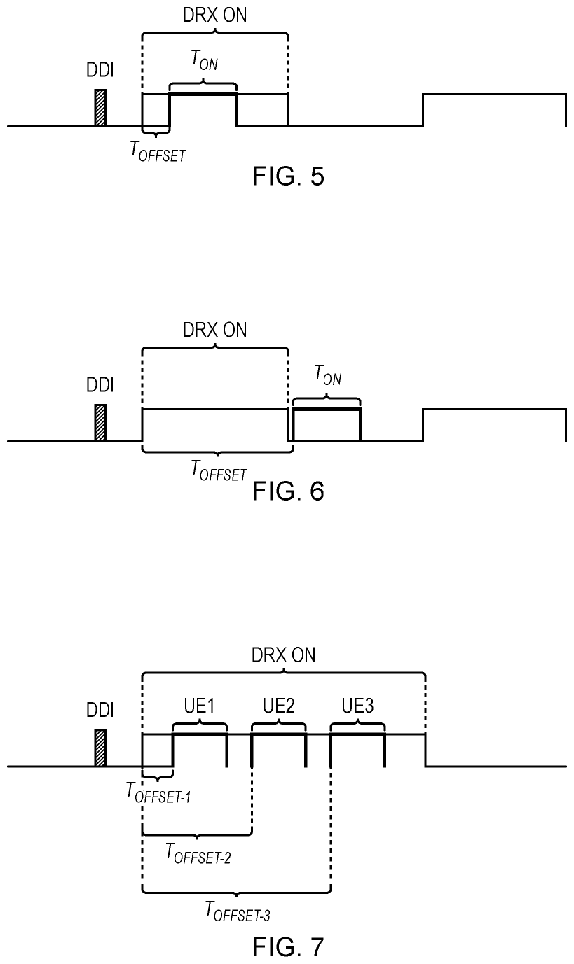

In the example illustrated by FIG. 5, T_{ON} is less than the original DRX ON duration and contained within the DRX ON duration, which would mitigate against the UE missing the DDI. However, it should be appreciated that this arrangement is not limited to just this case and that T_{ON} can be larger than DRX ON and T_{OFFSET} can be set such that the updated ON duration falls outside of the original DRX ON period as shown in FIG. 6. This has the benefit that the network can delay its scheduling for a UE after the DRX ON period if say the DRX ON duration is congested. The UE therefore can go to sleep during the DRX ON period and wake up only after T_{OFFSET}.

It should be noted that different UEs sharing the same DRX ON duration can be configured to have different T_{OFFSET} and T_{ON} parameters. For example, the network can configure these parameters such that the T_{ON} for different UEs do not overlap each other as shown in an example in FIG. 7 where here 3 UEs0 are indicated to update their DRX ON duration via the DDI (note there can be 3 DDIs or a single one addressing all 3 UEs) and each has a different T_{OFFSET}, i.e. T_{OFFSET-1} for UE1, T_{OFFSET-2} for UE2 and T_{OFFSET-3} for UE3, where these offsets are configured such that the ON duration of these 3 UEs do not collide. In other words, the DDI indicates that the DRX operation should be updated by a plurality of communications devices including the communications device 401, each of the plurality of communications devices operating in accordance with the same DRX operation, wherein the DDI indicates that the DRX operation should be updated by the communications device differently to one or more of the others of the plurality of communications devices. Alternatively, the DDI is one of a plurality of DDIs each indicating that the DRX operation should be updated by one of a plurality of communications devices including the communications device 401, each of the plurality of communications devices operating in accordance with the same DRX operation, wherein the DDI indicates that the DRX operation should be updated by the communications device differently to one or more of the others of the plurality of communications devices.

In another arrangement of embodiments of the present technique, the parameters T_{OFFSET} and T_{ON} (i.e. the offset period and the new active period) are explicitly signalled in the DDI.

In another arrangement of embodiments of the present technique, the parameters T_{OFFSET} and T_{ON} are RRC configured and the indicator in the DDI consists of an activation signal, e.g. a bit to activate the update to the ON duration. In other words, one or both of the offset period and the new active period are configured via Radio Resource Control, RRC, signalling, and wherein the DDI comprises an activation signal indicating that one or both of the offset period and the new active period should be updated.

In another arrangement of embodiments of the present technique, the parameters T_{OFFSET} and T_{ON} are implicitly derived from the UE ID (e.g. C-RNTI). This allows the DDI to address a group of UEs and each UE would derive the T_{OFFSET} and T_{ON} based on its UE ID. In other words, the communications device is configured to implicitly determine, based on an identifier associated with the communications device, one or both of the offset period and the new active period.

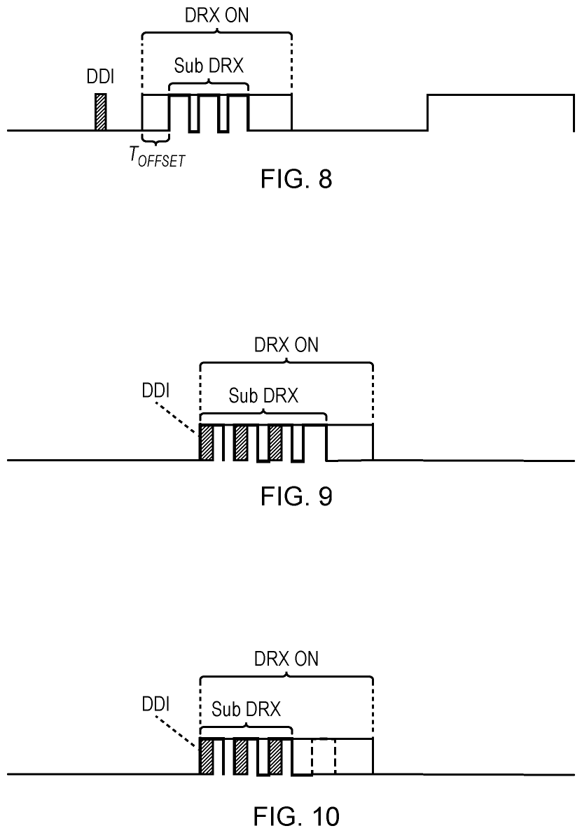

In another arrangement of embodiments of the present technique, the DDI indicates parameters for sub-DRX cycles. In other words, the DDI indicates that the communications device should operate in accordance with a sub-DRX cycle for a specified period of time, the sub-DRX cycle having a shorter period than the DRX operation and instances of an active operating mode of the sub-DRX cycle being shorter in time than instances of the active operating mode of the DRX operation. An example of this arrangement is shown in FIG. 8, where the DDI indicates a set of sub-DRX cycles that starts after a delay of T_{OFFSET}. The sub-DRX cycle has a shorter DRX period than the original DRX cycle and a smaller DRX ON duration. In this example, the sub-DRX cycle is completely contained within the DRX ON duration (the aspect of being completely contained within the DRX ON duration is beneficial since it mitigates against the UE missing the indicator in the DDI). However, it should be appreciated that this arrangement does not exclude the case where the sub-DRX cycle extends outside of the DRX ON duration. It will be appreciated that the sub-DRX cycle functionality can be implemented as a pattern for reduced PDCCH monitoring. For example, if the sub-DRX cycle causes the UE to be “on” for 1 slot and “off” for 3 slots, this sub-DRX cycle can be implemented as a reduced PDCCH monitoring pattern where 0the UE monitors PDCCH in every 4^{th} slot.

In some sub-DRX related arrangements of embodiments of the present technique, the DDI acts as a “keep alive” indicator within the DRX ON period. If the DDI is active within a sub-DRX of the DRX ON period, it indicates that the subsequent sub-DRX of the DRX ON period is active. In other words, if the communications device detects the DDI during one of the instances of the active operating mode of the sub-DRX cycle, the communications device determines that there is another instance of the active operating mode of the sub-DRX cycle after the one of the instances of the active operating mode of the sub-DRX cycle. This is illustrated in FIG. 9, where the first three sub-DRX of the DRX ON period contain active DDIs, indicating that the first four sub-DRX periods are active. The fourth sub-DRX period does not contain an active DDI, indicating that there are no further active sub-DRX periods within the DRX ON period. In other words, if the communications device does not detect the DDI during one of the instances of the active operating mode of the sub-DRX cycle, the communications device determines that it should switch into the reduced power operating mode, after the one of the instances of the active operating mode of the sub-DRX cycle, for the remainder of the sub-DRX cycle.

It will be appreciated that the “keep alive” functionality can also be implemented in a manner where the DDI indicates whether the current sub-DRX period is active or not and if a sub-DRX period is inactive, all further sub-DRX periods within the DRX ON period are understood to be inactive. In other words, if the communications device detects the DDI during one of the instances of the active operating mode of the sub-DRX cycle, the communications device determines that the communications device should search for a DDI during a next instance of the active operating mode of the sub-DRX cycle after the one of the instances of the active operating mode of the sub-DRX cycle. This is illustrated in FIG. 10, which shows that there are DDIs for the first 3 sub-DRX periods: these DDI indicate that those sub-DRX periods are active and cause the UE to search for a DDI in the subsequent sub-DRX period. The fourth sub-DRX period does not contain a DDI: this means that the UE does not decode PDCCH within this sub DRX period and goes to sleep for the remainder of the DRX ON period. In other words, if the communications device does not detect the DDI during one of the instances of the active operating mode of the sub-DRX cycle, the communications device determines that it should immediately switch into the reduced power operating mode for the remainder of the sub-DRX cycle.

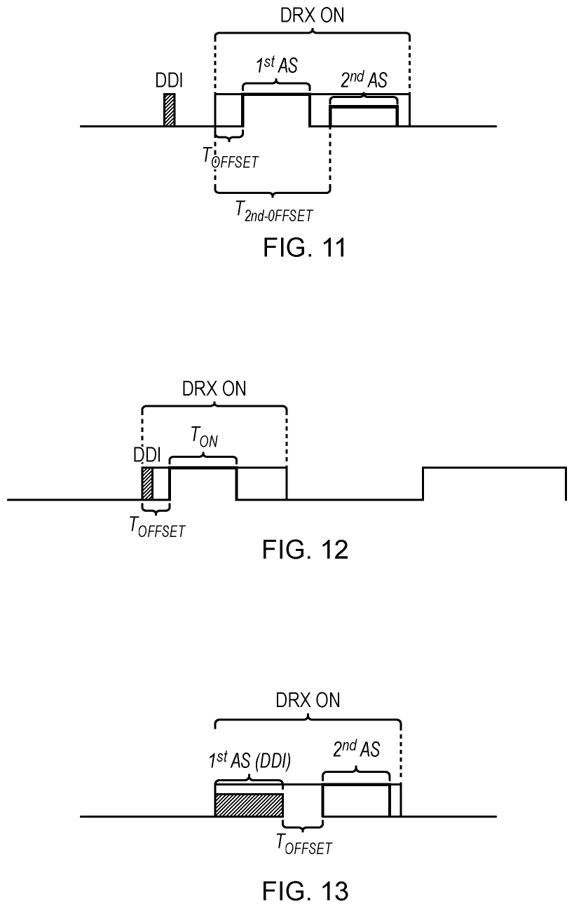

In another arrangement of embodiments of the present technique, the DDI indicates two Active States (ASs) during the DRX ON duration. In other words, the DDI indicates a plurality of active DRX states, a first of the active DRX states lasting for the new active period and being offset from the default time at which the communications device should switch into the active operating mode by the offset period, and a second of the active DRX states lasting for a second new active period and being offset from the default time at which the communications device should switch into the active operating mode by a second offset period. Similar to previous arrangements, the 1^{st} AS starts T_{OFFSET} from the beginning of the DRX ON duration and with a period of T_{ON} and the 2^{nd} AS starts T_{2nd-OFFSET} from the beginning of the DRX ON duration with a period of T_{2nd-ON}. An example is shown in FIG. 11, where the 1^{st} AS starts after T_{OFFSET} and the 2^{nd} AS starts after T_{2nd-OFFSET} (i.e. the second offset period of the second active DRX state is longer than the offset period of the first active DRX state). The signalling overhead can be reduced, for example, with the DDI indicating the 1^{st} AS and the 2^{nd} AS following immediately after the 1^{st} AS for the remaining DRX ON duration. The 1^{st} Active State may be associated with a higher decoding complexity, requiring higher power consumption to decode, than the 2^{nd} Active State. The higher decoding complexity may be because there is a greater number of signals to be decoded during the first new active period than the second new active period (e.g. more PDCCHs in the search space) or that the decoding of the signals is harder for the UE in the first new active period (e.g. because the signals are transmitted with a higher number of transmit antennas or on a greater number of beams than those in the second new active period). In other words, the communications device is configured to receive a greater number of signals and/or signals having a higher decoding complexity during the new active period of the first active DRX state than during the second new active period of the second active DRX state. For example the 1^{st} AS is where the UE monitors a full set of PDCCH search spaces (as per legacy system) and in the second Active State the UE would:
1) Turn off, i.e. this is similar to the previous arrangement shown in FIG. 5; or
2) Reduce the PDCCH monitoring, e.g. reduce the number of search spaces monitored per slot or reduce the number of blind decodes (i.e. PDCCH candidates) in each search space.

In either of the above cases, the reduced decoding complexity in the second active state results in a lower power consumption during the second active state.

In another arrangement of embodiments of the present technique, the DDI indicates whether the DRX ON period should be interpreted as operating in a power saving mode or in a legacy mode. In other words, the DDI indicates whether the communications device should operate in a first (power saving) mode in accordance with the plurality of active DRX states or whether the communications device should operate in a second (legacy) mode in accordance with the default DRX operation. For example, the presence of DDI in FIG. 11 can indicate that the DRX ON period operates in a power saving mode with two active states or in a legacy mode (where the UE decodes PDCCH throughout the DRX ON period).

In another arrangement of embodiments of the present technique, the DDI is carried by a Wake Up Signal (WUS). As described in [3], [4], [5], [6], a WUS is a signal that is transmitted prior to a DRX ON duration (such as a Paging Occasion) to indicate that there is potential traffic for the UE in the corresponding DRX ON duration. An absence of the WUS indicates that there is no traffic in the corresponding DRX ON duration. In this arrangement, the DDI is carried by the WUS, e.g. as another field in the WUS. The DDI can be implicitly carried by the WUS, e.g. the presence of the WUS would indicate the DDI is activated.

In another arrangement of embodiments of the present technique, the DDI is a Go To Sleep (GTS) or Go To Sleep And Wake Up Signal (GUS). The GTS (or GUS) is similar to a WUS except that the presence of the GTS indicates that there is no traffic in the corresponding DRX ON duration whilst an absence of the GTS indicates that there is potential traffic in the corresponding DRX ON duration. The GUS explicitly indicates either “wake up” or “go to sleep” and is always present before the corresponding DRX ON duration. Hence, in the GUS case, in addition to indicating whether the DRX ON duration is activated or not, it also indicates its characteristics (e.g. as previously described). In the GTS-based arrangement, the DDI can be used to indicate a lower powered DRX ON duration or that the corresponding DRX ON duration is deactivated.

In another arrangement of embodiments of the present technique, the DDI is carried by a DCI. This can be a compact DCI, i.e. a DCI that is “light weight” and only contains the necessary information required by the DDI. The DDI can alternatively be transmitted as a bit field within a DCI that is used for other purposes (e.g. the DDI can be transmitted as a bit field within a DCI that schedules DL or UL resource). In this arrangement the DDI may be transmitted within the DRX ON duration as shown in FIG. 12. In the example shown, the compact-DCI-coded DDI indicates that the UE should wake up for a duration of T_{ON} after a time T_{OFFSET}; outside of this time window, the UE can go to sleep. It should be noted that if the UE does not receive this DDI, the UE would remain awake. This has the benefit that if the network is heavily loaded, and hence cannot transmit additional compact DCIs (e.g. one carrying DCI), the UE is still able to monitor for received PDCCHs.

In another arrangement of embodiments of the present technique, the DDI is implicit. For example, if a DCI is received in a first portion of the DRX ON period, the UE receives the further second portion of the DRX ON period; if no DCI is received in a first portion of the DRX ON period, the UE can go to sleep for the further second portion of the DRX ON period. In other words, the communications device is configured to determine, based on at least one other received signal, that a DDI has been implicitly received. The at least one other received signal may be a DCI which is received by the communications device in a first portion of an instance of the active operating mode, the DCI indicating that the communications device should monitor a second portion of the instance of the active operating mode for a second DCI.

One action in accordance with (legacy) behaviour that a UE may take when it detects a PDCCH (DCI) is that it will start an Inactivity Timer and this Inactivity Timer can be longer than the DRX ON duration. In other words, in response to receiving the DCI comprising the DDI, the communications device is configured to start an inactivity timer specifying a period during which the communications device remains in the active operating mode. This behaviour can be used to prolong the DRX ON duration for example by transmitting a compact DCI containing DDI at the end of the DRX ON duration.

In an aspect of this arrangement related to the base station, when the DRX ON duration is congested (e.g. many UEs need to be scheduled within the DRX ON duration), at the start of the DRX ON duration, the base station sends compact DCIs to those UEs that will be scheduled towards the end of the DRX ON duration. Such UEs will thus start their inactivity timers such that they can be scheduled beyond the end of the DRX ON duration. In other words, wherein the infrastructure equipment is configured to transmit the DDI to the communications device during an instance of the active operating mode of the DRX operation of the communications device, at a time from which the period specified by the inactivity timer is longer than a period of time remaining of the instance of the active operating mode of the DRX operation of the communications device.

In an arrangement of embodiments of the present technique, there are two active states, as described above with relation to FIG. 11, but where the first active state enables a lower power operation than the second active state (i.e. the opposite of the arrangement shown in FIG. 11). In other words, the DDI indicates a plurality of active DRX states, a first of the active DRX states lasting for the new active period and being offset from the default time at which the communications device should switch into the active operating mode by the offset period, and a second of the active DRX states lasting for a second new active period and being offset from the default time at which the communications device should switch into the active operating mode by a second offset period, wherein the communications device is configured to receive a greater number of signals and/or signals having a higher decoding complexity (that typically require a higher power consumption to decode) during the second new active period of the second active DRX state than during the new active period of the first active DRX state. In the first AS, DCIs are transmitted that indicate which UEs are to be scheduled in the second AS. These DCIs can, for example, be transmitted in the form of compact DCIs. In the second AS, the UE decodes full search spaces that contain normal DCIs. In other words, the communications device is configured to receive a set of Downlink Control Indication, DCI, messages during the first active DRX state, the DCI messages indicating whether the communications device is to receive a downlink signal from the infrastructure equipment during the second active DRX state, or whether the communications device is to switch into the reduced power operating mode during the second active DRX state. This mode of operation allows the network to signal (in the first AS), which UEs need to monitor (using a higher power consumption) in the second AS. UEs that do not receive a compact DCI in the first AS can return to a low power after the conclusion of the first AS (and hence not decode the 2^{nd} AS or the remainder of the DRX ON period). The first AS hence acts as a DDI for the second AS. This arrangement is illustrated in FIG. 13.

While described in the form of the first AS transmitting compact DCIs, it will be appreciated that normal DCIs (e.g. DCIs scheduling DL or UL data) can be transmitted in the first AS. If the UE receives an allocation via a normal DCI during the first AS, this is understood to be an implicit indication that the UE should monitor the second AS for further DCIs, as described above in relation to the arrangement of the implicit DDI.

In another arrangement of embodiments of the present technique, the DDI is UE specific. That is, a DDI is transmitted to a single UE and therefore can contain tailored parameters for that UE. A DCI-based DDI (e.g. a compact DCI) is particularly suited to this arrangement, since the DCI carries the UE identity (e.g. through masking the CRC of the DCI with the UE's C-RNTI). Alternatively, in another arrangement of embodiments of the present technique, the DDI is group specific. That is the DDI is transmitted to a known group of UEs. This can be carried by a Group Common DCI or a WUS/GTS that addresses a group of UEs. The grouping can be done via RRC configuration or based on UE ID.

In another arrangement of embodiments of the present technique the DDI affects more than one DRX ON duration. In previous arrangements, the DDI affects one corresponding (i.e. a DRX ON duration immediately after the DDI). Here this DDI can be configured to affect multiple DRX ON durations. For example the DDI can affect the next X DRX ON durations where X is indicated in the DDI, RRC configurable or determined in the specs. In other words, the DDI indicates that a specified number of next instances of the active operating mode of the DRX operation should be updated by the communications device.

Flow Chart Representation

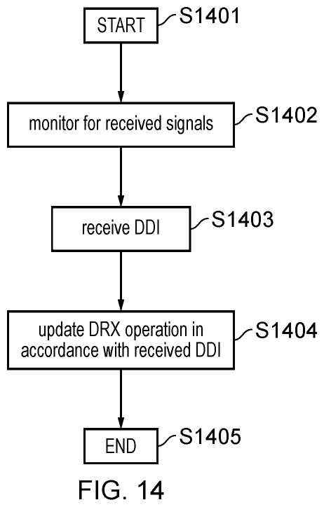

FIG. 14 shows a flow diagram illustrating a method of operating a communications device according to embodiments of the present technique. The communications device is configured to receive signals from an infrastructure equipment of a wireless communications network, and the communications device is configured to periodically switch between an active operating mode and a reduced power operating mode in accordance with a discontinuous reception, DRX, operation.

The method begins in step S1401. The method comprises, in step S1402, monitoring for signals transmitted by the infrastructure equipment via a wireless access interface provided by the wireless communications network to the communications device. In step S1403, the process comprises receiving via the wireless access interface, from the infrastructure equipment, a dynamic DRX indicator, DDI, the DDI indicating that the DRX operation should be updated by the communications device. The method then advances to step S1404, which comprises updating the DRX operation in accordance with the received DDI. The process ends in step S1405.

Those skilled in the art would appreciate that the method shown by FIG. 14 may be adapted in accordance with embodiments of the present technique. For example, other intermediate steps may be included in the method, or the steps may be performed in any logical order.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A communications device configured to receive signals from an infrastructure equipment of a wireless communications network, the communications device being configured to periodically switch between an active operating mode and a reduced power operating mode in accordance with a discontinuous reception, DRX, operation, the communications device comprising
transceiver circuitry configured to transmit signals and receive signals via a wireless access interface provided by the wireless communications network, and
controller circuitry configured to control the transceiver circuitry
to monitor for signals transmitted by the infrastructure equipment to the communications device,
to receive, from the infrastructure equipment, a dynamic DRX indicator, DDI, the DDI indicating that the DRX operation should be updated by the communications device, and
to update the DRX operation in accordance with the received DDI.

Paragraph 2. A communications device according to Paragraph 1, wherein the DDI is received by the communications device from the infrastructure equipment while the communications device is in the active operating mode.

Paragraph 3. A communications device according to Paragraph 1 or Paragraph 2, wherein the DDI indicates that the communications device should change a length of time for which the communications device is in the active operating mode from a default active period to a new active period.

Paragraph 4. A communications device according to Paragraph 3, wherein the DDI indicates an offset period from a default time at which the communications device should switch into the active operating mode to a new time at which the communications device should switch into the active operating mode.

Paragraph 5. A communications device according to Paragraph 4, wherein one or both of the offset period and the new active period are explicitly signalled in the DDI.

Paragraph 6. A communications device according to Paragraph 4 or Paragraph 5, wherein one or both of the offset period and the new active period are configured via Radio Resource Control, RRC, signalling, and wherein the DDI comprises an activation signal indicating that one or both of the offset period and the new active period should be updated.

Paragraph 7. A communications device according to any of Paragraphs 4 to 6, wherein the communications device is configured to implicitly determine, based on an identifier associated with the communications device, one or both of the offset period and the new active period.

Paragraph 8. A communications device according to any of Paragraphs 1 to 7, wherein the DDI indicates that the DRX operation should be updated by a plurality of communications devices including the communications device, each of the plurality of communications devices operating in accordance with the same DRX operation, wherein the DDI indicates that the DRX operation should be updated by the communications device differently to one or more of the others of the plurality of communications devices.

Paragraph 9. A communications device according to any of Paragraphs 1 to 8, wherein the DDI is one of a plurality of DDIs each indicating that the DRX operation should be updated by one of a plurality of communications devices including the communications device, each of the plurality of communications devices operating in accordance with the same DRX operation, wherein the DDI indicates that the DRX operation should be updated by the communications device differently to one or more of the others of the plurality of communications devices.

Paragraph 10. A communications device according to any of Paragraphs 1 to 10, wherein the DDI indicates that the communications device should operate in accordance with a sub-DRX cycle for a specified period of time, the sub-DRX cycle having a shorter period than the DRX operation and instances of an active operating mode of the sub-DRX cycle being shorter in time than instances of the active operating mode of the DRX operation.

Paragraph 11. A communications device according to Paragraph 10, wherein if the communications device detects the DDI during one of the instances of the active operating mode of the sub-DRX cycle, the communications device determines that there is another instance of the active operating mode of the sub-DRX cycle after the one of the instances of the active operating mode of the sub-DRX cycle.

Paragraph 12. A communications device according to Paragraph 10 or Paragraph 11, wherein if the communications device does not detect the DDI during one of the instances of the active operating mode of the sub-DRX cycle, the communications device determines that it should switch into the reduced power operating mode, after the one of the instances of the active operating mode of the sub-DRX cycle, for the remainder of the sub-DRX cycle.

Paragraph 13. A communications device according to any of Paragraphs 10 to 12, wherein if the communications device detects the DDI during one of the instances of the active operating mode of the sub-DRX cycle, the communications device determines that the communications device should search for a DDI during a next instance of the active operating mode of the sub-DRX cycle after the one of the instances of the active operating mode of the sub-DRX cycle.

Paragraph 14. A communications device according to any of Paragraphs 10 to 13, wherein if the communications device does not detect the DDI during one of the instances of the active operating mode of the sub-DRX cycle, the communications device determines that it should immediately switch into the reduced power operating mode for the remainder of the sub-DRX cycle.

Paragraph 15. A communications device according to any of Paragraphs 4 to 14, wherein the DDI indicates a plurality of active DRX states, a first of the active DRX states lasting for the new active period and being offset from the default time at which the communications device should switch into the active operating mode by the offset period, and a second of the active DRX states lasting for a second new active period and being offset from the default time at which the communications device should switch into the active operating mode by a second offset period.

Paragraph 16. A communications device according to Paragraph 15, wherein the second offset period of the second active DRX state is longer than the offset period of the first active DRX state.

Paragraph 17. A communications device according to Paragraph 15 or Paragraph 16, wherein the communications device is configured to receive a greater number of signals and/or signals having a higher decoding complexity during the new active period of the first active DRX state than during the second new active period of the second active DRX state.

Paragraph 18. A communications device according to any of Paragraphs 15 to 17, wherein the communications device is configured to receive a greater number of signals and/or signals having a higher decoding complexity during the second new active period of the second active DRX state than during the new active period of the first active DRX state.

Paragraph 19. A communications device according to Paragraph 18, wherein the communications device is configured to receive a set of Downlink Control Indication, DCI, messages during the first active DRX state, the DCI messages indicating whether the communications device is to receive a downlink signal from the infrastructure equipment during the second active DRX state, or whether the communications device is to switch into the reduced power operating mode during the second active DRX state.

Paragraph 20. A communications device according to any of Paragraphs 15 to 19, wherein the DDI indicates whether the communications device should operate in a first mode in accordance with the plurality of active DRX states or whether the communications device should operate in a second mode in accordance with the default DRX operation.

Paragraph 21. A communications device according to any of Paragraphs 1 to 20, wherein the DDI is received from the infrastructure equipment as part of a wake-up signal, WUS.

Paragraph 22. A communications device according to any of Paragraphs 1 to 21, wherein the DDI is received from the infrastructure equipment as part of a go-to-sleep signal, GTS.

Paragraph 23. A communications device according to any of Paragraphs 1 to 22, wherein the DDI is received from the infrastructure equipment as part of a DCI message.

Paragraph 24. A communications device according to Paragraph 23, wherein the DCI message is a compact DCI message and contains only information necessary to signal the DDI to the communications device.

Paragraph 25. A communications device according to Paragraph 23 or Paragraph 24, wherein in response to receiving the DCI comprising the DDI, the communications device is configured to start an inactivity timer specifying a period during which the communications device remains in the active operating mode.

Paragraph 26. A communications device according to any of Paragraphs 1 to 25, wherein the communications device is configured to determine, based on at least one other received signal, that a DDI has been implicitly received.

Paragraph 27. A communications device according to Paragraph 26, wherein the at least one other received signal is a DCI which is received by the communications device in a first portion of an instance of the active operating mode, the DCI indicating that the communications device should monitor a second portion of the instance of the active operating mode for a second DCI.

Paragraph 28. A communications device according to any of Paragraphs 1 to 27, wherein the DDI is specific to the communications device.

Paragraph 29. A communications device according to any of Paragraphs 1 to 28, wherein the DDI is specific to a group of communications devices, the group of communications devices comprising the communications device.

Paragraph 30. A communications device according to any of Paragraphs 1 to 29, wherein the DDI indicates that a specified number of next instances of the active operating mode of the DRX operation should be updated by the communications device.

Paragraph 31. A method of operating a communications device configured to receive signals from an infrastructure equipment of a wireless communications network, the communications device being configured to periodically switch between an active operating mode and a reduced power operating mode in accordance with a discontinuous reception, DRX, operation, the method comprising
monitoring for signals transmitted by the infrastructure equipment via a wireless access interface provided by the wireless communications network to the communications device,
receiving via the wireless access interface, from the infrastructure equipment, a dynamic DRX indicator, DDI, the DDI indicating that the DRX operation should be updated by the communications device, and
updating the DRX operation in accordance with the received DDI.

Paragraph 32. Circuitry for a communications device configured to receive signals from an infrastructure equipment of a wireless communications network, the communications device being configured to periodically switch between an active operating mode and a reduced power operating mode in accordance with a discontinuous reception, DRX, operation, the communications device comprising
transceiver circuitry configured to transmit signals and receive signals via a wireless access interface provided by the wireless communications network, and
controller circuitry configured to control the transceiver circuitry
to monitor for signals transmitted by the infrastructure equipment to the communications device,
to receive, from the infrastructure equipment, a dynamic DRX indicator, DDI, the DDI indicating that the DRX operation should be updated by the communications device, and
to update the DRX operation in accordance with the received DDI.

Paragraph 33. An infrastructure equipment forming part of a wireless communications network configured to transmit signals to a communications device, the communications device being configured to periodically switch between an active operating mode and a reduced power operating mode in accordance with a discontinuous reception, DRX, operation, the infrastructure equipment comprising
transceiver circuitry configured to transmit signals and receive signals via a wireless access interface provided by the wireless communications network, and
controller circuitry configured to control the transceiver circuitry
to transmit, to the communications device, a dynamic DRX indicator, DDI, the DDI indicating that the DRX operation should be updated by the communications device, and
to transmit signals to the communications device in accordance with the updated DRX operation indicated by the transmitted DDI.

Paragraph 34. An infrastructure equipment according to Paragraph 33, wherein the DDI is transmitted by the infrastructure equipment to the communications device while the communications device is in the active operating mode.

Paragraph 35. An infrastructure equipment according to Paragraph 33 or Paragraph 34, wherein the DDI indicates that the communications device should change a length of time for which the communications device is in the active operating mode from a default active period to a new active period.

Paragraph 36. An infrastructure equipment according to Paragraph 35, wherein the DDI indicates an offset period from a default time at which the communications device should switch into the active operating mode to a new time at which the communications device should switch into the active operating mode.

Paragraph 37. An infrastructure equipment according to Paragraph 36, wherein one or both of the offset period and the new active period are explicitly signalled in the DDI.

Paragraph 38. An infrastructure equipment according to Paragraph 36 or Paragraph 37, wherein one or both of the offset period and the new active period are configured via Radio Resource Control, RRC, signalling transmitted by the infrastructure equipment to the communications device, and wherein the DDI comprises an activation signal indicating that one or both of the offset period and the new active period should be updated.

Paragraph 39. An infrastructure equipment according to any of Paragraphs 33 to 38, wherein the DDI indicates that the DRX operation should be updated by a plurality of communications devices including the communications device, each of the plurality of communications devices operating in accordance with the same DRX operation, wherein the DDI indicates that the DRX operation should be updated by the communications device differently to one or more of the others of the plurality of communications devices.

Paragraph 40. An infrastructure equipment according to any of Paragraphs 33 to 39, wherein the DDI is one of a plurality of DDIs each indicating that the DRX operation should be updated by one of a plurality of communications devices including the communications device, each of the plurality of communications devices operating in accordance with the same DRX operation, wherein the DDI indicates that the DRX operation should be updated by the communications device differently to one or more of the others of the plurality of communications devices.

Paragraph 41. An infrastructure equipment according to any of Paragraphs 33 to 40, wherein the DDI indicates that the communications device should operate in accordance with a sub-DRX cycle for a specified period of time, the sub-DRX cycle having a shorter period than the DRX operation and instances of an active operating mode of the sub-DRX cycle being shorter in time than instances of the active operating mode of the DRX operation.

Paragraph 42. An infrastructure equipment according to any of Paragraphs 36 to 41, wherein the DDI indicates a plurality of active DRX states, a first of the active DRX states lasting for the new active period and being offset from the default time at which the communications device should switch into the active operating mode by the offset period, and a second of the active DRX states lasting for a second new active period and being offset from the default time at which the communications device should switch into the active operating mode by a second offset period.

Paragraph 43. An infrastructure equipment according to Paragraph 42, wherein the second offset period of the second active DRX state is longer than the offset period of the first active DRX state.

Paragraph 44. An infrastructure equipment according to Paragraph 42 or Paragraph 43, wherein the infrastructure equipment transmits a greater number of signals and/or signals having a higher decoding complexity to the communications device during the new active period of the first active DRX state than during the second new active period of the second active DRX state.

Paragraph 45. An infrastructure equipment according to any of Paragraphs 42 to 44, wherein the infrastructure equipment transmits a greater number of signals and/or signals having a higher decoding complexity to the communications device during the second new active period of the second active DRX state than during the new active period of the first active DRX state.

Paragraph 46. An infrastructure equipment according to Paragraph 45, wherein the infrastructure equipment is configured to transmit a set of Downlink Control Indication, DCI, messages to the communications device during the first active DRX state, the DCI messages indicating whether the infrastructure equipment is going to transmit a downlink signal to the communications device during the second active DRX state, or whether the communications device is to switch into the reduced power operating mode during the second active DRX state.

Paragraph 47. An infrastructure equipment according to any of Paragraphs 42 to 46, wherein the DDI indicates whether the communications device should operate in a first mode in accordance with the plurality of active DRX states or whether the communications device should operate in a second mode in accordance with the default DRX operation.

Paragraph 48. An infrastructure equipment according to any of Paragraphs 33 to 47, wherein the DDI is transmitted by the infrastructure equipment to the communications device as part of a wake-up signal, WUS.

Paragraph 49. An infrastructure equipment according to any of Paragraphs 33 to 48, wherein the DDI transmitted by the infrastructure equipment to the communications device as part of a go-to-sleep signal, GTS.

Paragraph 50. An infrastructure equipment according to any of Paragraphs 33 to 49, wherein the DDI is transmitted by the infrastructure equipment to the communications device as part of a DCI message.

Paragraph 51. An infrastructure equipment according to Paragraph 50, wherein the DCI message is a compact DCI message and contains only information necessary to signal the DDI to the communications device.

Paragraph 52. An infrastructure equipment according to Paragraph 50 or Paragraph 51, wherein the DDI indicates that the communications device is to start an inactivity timer specifying a period during which the communications device remains in the active operating mode.

Paragraph 53. An infrastructure equipment according to Paragraph 52, wherein the infrastructure equipment is configured to transmit the DDI to the communications device during an instance of the active operating mode of the DRX operation of the communications device, at a time from which the period specified by the inactivity timer is longer than a period of time remaining of the instance of the active operating mode of the DRX operation of the communications device.

Paragraph 54. An infrastructure equipment according to any of Paragraphs 33 to 53, wherein the infrastructure equipment is configured to transmit at least one other signal to the communications device, the at least one other signal implicitly indicating that a DDI has been transmitted.

Paragraph 55. An infrastructure equipment according to Paragraph 54, wherein the at least one other received signal is a DCI which is transmitted by the infrastructure equipment to the communications device in a first portion of an instance of the active operating mode, the DCI indicating that the communications device should monitor a second portion of the instance of the active operating mode for a second DCI.

Paragraph 56. An infrastructure equipment according to any of Paragraphs 33 to 55, wherein the DDI is specific to the communications device.

Paragraph 57. An infrastructure equipment according to any of Paragraphs 33 to 56, wherein the DDI is specific to a group of communications devices, the group of communications devices comprising the communications device.

Paragraph 58. An infrastructure equipment according to any of Paragraphs 33 to 57, wherein the DDI indicates that a specified number of next instances of the active operating mode of the DRX operation should be updated by the communications device.

Paragraph 59. A method of operating an infrastructure equipment forming part of a wireless communications network configured to transmit signals to a communications device, the communications device being configured to periodically switch between an active operating mode and a reduced power operating mode in accordance with a discontinuous reception, DRX, operation, the method comprising
transmitting via a wireless access interface provided by the wireless communications network, to the communications device, a dynamic DRX indicator, DDI, the DDI indicating that the DRX operation should be updated by the communications device, and
transmitting signals via the wireless access interface to the communications device in accordance with the updated DRX operation indicated by the transmitted DDI.

Paragraph 60. Circuitry for an infrastructure equipment forming part of a wireless communications network configured to transmit signals to a communications device, the communications device being configured to periodically switch between an active operating mode and a reduced power operating mode in accordance with a discontinuous reception, DRX, operation, the infrastructure equipment comprising
transceiver circuitry configured to transmit signals and receive signals via a wireless access interface provided by the wireless communications network, and
controller circuitry configured to control the transceiver circuitry
to transmit, to the communications device, a dynamic DRX indicator, DDI, the DDI indicating that the DRX operation should be updated by the communications device, and to transmit signals to the communications device in accordance with the updated DRX operation indicated by the transmitted DDI.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.

[2] RP-172834, “Revised WID on New Radio Access Technology,” NTT DOCOMO, RAN#78.

[3] European Patent Applicant No. EP17169577.8.

[4] European Patent Applicant No. EP17186065.3.

[5] European Patent Applicant No. EP17186062.0.

[6] European Patent Applicant No. EP17201751.9.

[7] R1-1708311, “Idle Mode Power Efficiency Reduction,” Sierra Wireless, RAN1#89.

1. A communications device configured to receive signals from an infrastructure equipment of a wireless communications network, the communications device being configured to periodically switch between an active operating mode and a reduced power operating mode in accordance with a discontinuous reception, DRX, operation, the communications device comprising
transceiver circuitry configured to transmit signals and receive signals via a wireless access interface provided by the wireless communications network, and
controller circuitry configured to control the transceiver circuitry
to monitor for signals transmitted by the infrastructure equipment to the communications device,
to receive, from the infrastructure equipment, a dynamic DRX indicator, DDI, the DDI indicating that the DRX operation should be updated by the communications device, and
to update the DRX operation in accordance with the received DDI.

2. A communications device according to claim 1, wherein the DDI is received by the communications device from the infrastructure equipment while the communications device is in the active operating mode.

3. A communications device according to claim 1, wherein the DDI indicates that the communications device should change a length of time for which the communications device is in the active operating mode from a default active period to a new active period.

4. A communications device according to claim 3, wherein the DDI indicates an offset period from a default time at which the communications device should switch into the active operating mode to a new time at which the communications device should switch into the active operating mode.

5. A communications device according to claim 4, wherein one or both of the offset period and the new active period are explicitly signalled in the DDI.

6. A communications device according to claim 4, wherein one or both of the offset period and the new active period are configured via Radio Resource Control, RRC, signalling, and wherein the DDI comprises an activation signal indicating that one or both of the offset period and the new active period should be updated.

7. A communications device according to claim 4, wherein the communications device is configured to implicitly determine, based on an identifier associated with the communications device, one or both of the offset period and the new active period.

8. A communications device according to claim 1, wherein the DDI indicates that the DRX operation should be updated by a plurality of communications devices including the communications device, each of the plurality of communications devices operating in accordance with the same DRX operation, wherein the DDI indicates that the DRX operation should be updated by the communications device differently to one or more of the others of the plurality of communications devices.

9. A communications device according to claim 1, wherein the DDI is one of a plurality of DDIs each indicating that the DRX operation should be updated by one of a plurality of communications devices including the communications device, each of the plurality of communications devices operating in accordance with the same DRX operation, wherein the DDI indicates that the DRX operation should be updated by the communications device differently to one or more of the others of the plurality of communications devices.

10. A communications device according to claim 1, wherein the DDI indicates that the communications device should operate in accordance with a sub-DRX cycle for a specified period of time, the sub-DRX cycle having a shorter period than the DRX operation and instances of an active operating mode of the sub-DRX cycle being shorter in time than instances of the active operating mode of the DRX operation.

11.-32. (canceled)

33. An infrastructure equipment forming part of a wireless communications network configured to transmit signals to a communications device, the communications device being configured to periodically switch between an active operating mode and a reduced power operating mode in accordance with a discontinuous reception, DRX, operation, the infrastructure equipment comprising
transceiver circuitry configured to transmit signals and receive signals via a wireless access interface provided by the wireless communications network, and
controller circuitry configured to control the transceiver circuitry
to transmit, to the communications device, a dynamic DRX indicator, DDI, the DDI indicating that the DRX operation should be updated by the communications device, and
to transmit signals to the communications device in accordance with the updated DRX operation indicated by the transmitted DDI.

34. An infrastructure equipment according to claim 33, wherein the DDI is transmitted by the infrastructure equipment to the communications device while the communications device is in the active operating mode.

35. An infrastructure equipment according to claim 33, wherein the DDI indicates that the communications device should change a length of time for which the communications device is in the active operating mode from a default active period to a new active period.

36. An infrastructure equipment according to claim 35, wherein the DDI indicates an offset period from a default time at which the communications device should switch into the active operating mode to a new time at which the communications device should switch into the active operating mode.

37. An infrastructure equipment according to claim 36, wherein one or both of the offset period and the new active period are explicitly signalled in the DDI.

38. An infrastructure equipment according to claim 36, wherein one or both of the offset period and the new active period are configured via Radio Resource Control, RRC, signalling transmitted by the infrastructure equipment to the communications device, and wherein the DDI comprises an activation signal indicating that one or both of the offset period and the new active period should be updated.

39. An infrastructure equipment according to claim 33, wherein the DDI indicates that the DRX operation should be updated by a plurality of communications devices including the communications device, each of the plurality of communications devices operating in accordance with the same DRX operation, wherein the DDI indicates that the DRX operation should be updated by the communications device differently to one or more of the others of the plurality of communications devices.

40. An infrastructure equipment according to claim 33, wherein the DDI is one of a plurality of DDIs each indicating that the DRX operation should be updated by one of a plurality of communications devices including the communications device, each of the plurality of communications devices operating in accordance with the same DRX operation, wherein the DDI indicates that the DRX operation should be updated by the communications device differently to one or more of the others of the plurality of communications devices.

41. An infrastructure equipment according to claim 33, wherein the DDI indicates that the communications device should operate in accordance with a sub-DRX cycle for a specified period of time, the sub-DRX cycle having a shorter period than the DRX operation and instances of an active operating mode of the sub-DRX cycle being shorter in time than instances of the active operating mode of the DRX operation.

42.-58. (canceled)

59. A method of operating an infrastructure equipment forming part of a wireless communications network configured to transmit signals to a communications device, the communications device being configured to periodically switch between an active operating mode and a reduced power operating mode in accordance with a discontinuous reception, DRX, operation, the method comprising
transmitting via a wireless access interface provided by the wireless communications network, to the communications device, a dynamic DRX indicator, DDI, the DDI indicating that the DRX operation should be updated by the communications device, and transmitting signals via the wireless access interface to the communications device in accordance with the updated DRX operation indicated by the transmitted DDI.

60. (canceled)
